(19) United States
(12) Patent Application Publication
(10) Pub. No.: US 2016/0225115 A1
(43) Pub. Date: Aug. 4, 2016

(54) Transportation System Using Crowdsourced Warehouses and Storage Facilities

(71) Applicants: James A. Levy, Palo Alto, CA (US); George S. Levy, San Diego, CA (US)

(72) Inventors: James A. Levy, Palo Alto, CA (US); George S. Levy, San Diego, CA (US)

(21) Appl. No.: 15/011,535

(22) Filed: Jan. 30, 2016

Related U.S. Application Data
(60) Provisional application No. 62/110,577, filed on Feb. 1, 2015.

(51) Int. Cl. G06Q 50/28; G06Q 50/30; G06Q 50/00; G06Q 10/08

(52) U.S. Cl. CPC G06Q 50/28; G06Q 10/087; G06Q 50/30; G06Q 50/01

(57) ABSTRACT

The invention crowdsources and coordinates the operation of residential, commercial or industrial warehouses as well as vehicles for the purpose of transporting parcels. The invention also coordinates these crowdsourced facilities with non-crowdsourced warehouses and vehicles. The invention also includes an Internet marketplace that may operate as an auction, for exchanging payments for transportation and storage services rendered. Participants use communication devices to enter their daily and hourly availability into a database operated by a Cloud-hosted app. This app assigns drivers and warehouses, proposes routes, estimates pick-up and drop-off times, tracks vehicles, issue a transaction notice before an impending pick-up or drop-off, verifies the validity of each transaction and updates the custody data assigned to each parcel after an exchange. Participants utilize communication devices that allows them to send GPS data to the Cloud app, verify each others' identity, identify exchanged parcels and communicate transaction data with the Cloud app.

### FIELD OF THE INVENTION

This invention claims the benefit of US Provisional Application No. 62110577 with the title, “Transportation System Using Crowdsourced Warehouses and Storage Facilities” filed on Feb. 1, 2015 and which is hereby incorporated by reference. Applicant claims priority pursuant to 35 U.S.C. Par 119(e)(i).

The present invention relates to the crowdsourcing of transportation assets, more specifically, to the crowdsourcing of warehouses. It also relates to the coordination in their utilization with crowdsourced vehicles.

### BACKGROUND

In a commercial transportation system goods are transported from suppliers to warehouses and from warehouses to consumers. Such a system is a network comprised of links and nodes. The links are embodied by the routes followed by the trucking vehicles, and the nodes by warehouses or storage locations. Usually a route taken by a given package includes several warehouse stops. Therefore the route is restricted by warehouse locations and may not be the shortest path given the available roads. Increasing the number of warehouses, that is, improving the spatial resolution of the transportation network, could decrease the distance travelled and reduce the cost and time of transporting packages.

Furthermore, the transportation network is also characterized by timing considerations, that is, the scheduled time of arrival and departure of transportation vehicles. For example, trucks may wait to be full to leave a location. Increasing the number of vehicles could also improve the speed of delivery.

Another concern is the large number of vehicles on the road carrying a single person, the driver. There may be opportunities to use these lightly loaded vehicles to carry packages between points along their preset itinerary.

Yet one more consideration is the large number of lightly occupied (industrial, commercial and residential) buildings which could be put to good use for storage purposes.

Further features, aspects, and advantages of the present invention over the prior art will be more fully understood when considered with respect to the following detailed description and claims.

### SUMMARY OF THE INVENTION

Given the need for inexpensive and fast transportation, and the underutilization of a large number of storage sites and transportation vehicles, there is an opportunity to crowdsource these storage sites and vehicles and coordinate their operation.

The invention crowdsources residential, commercial or industrial warehousing facilities as well as vehicles and coordinates their operation for the purpose of transporting parcels. The invention also coordinates these crowdsourced facilities with non-crowdsourced commercial warehouses and transportation vehicles. The invention can also include an Internet marketplace for exchanging payments for transportation and storage service rendered.

Each participant uses his communication device to enter his or her daily and hourly availability into a database operated by an app hosted in the Cloud—for example a server on the Internet, running the app. This app assigns vehicle drivers to transport parcels between warehouses or between senders and warehouses or between warehouses and receivers. The app also proposes routes for vehicles, and estimates pick-up and drop-off times. Using GPS data from the participants, the Cloud app tracks the location of vehicles (and of the parcels that vehicles carry,) and warns participants of impending parcel pick-ups and drop-offs. The Cloud app also validates proposed transactions, and updates the custody of a parcel after the parcel has changed hands. The Cloud app also maintains a “reputation” database to monitor the performance of the warehouse operators and drivers.

Participants run an app on their communication device that allows them to communicate with the Cloud app. The communication app collects local GPS data and sends it to the Cloud app. The communication app warns the user of an impending transaction and assists in the performance of the transaction. Using a bar-code or RFID or other such identification method, the communication identifies parcels which are being exchanged. It also verifies the identity of the other party in the transaction process. It then sends the proposed transaction data to the Cloud app for validation and authorization. Finally after a transaction is completed it sends a completed signal to the Cloud to allow a non-transitory change in custody in the record of the parcel being exchanged.

The transportation system uses a crowdsourcing approach for transporting a parcel from a sender to a receiver. The transportation system comprises:
1. a network such as the Internet.
2. a remote server connected to the network.
3. a number of proposed warehouses operated by a number of proposing warehouse operators.
4. non-transitory warehouse data (such as location, time and day availability, storage area, security features, electronic key access etc.) is sent by the proposing warehouse operators over the network to the server. This warehouse data is stored by the server, and used to select from the proposed warehouses, a contributed warehouse operated by a contributing warehouse operator.
   The contributed warehouse is used as a stop along a route used to transport the parcel.

The above transportation system can also comprise crowdsourced vehicles:
1. A number of proposed vehicles operated by a number of proposing vehicle drivers.
2. Non-transitory vehicle data sent by the proposing vehicle's drivers over the network to the server. The vehicle data is stored by said server, and used to select from the proposed vehicles, a contributed vehicle operated by a contributing vehicle driver.
3. The contributed vehicle is used along a leg of the route used to transport the parcel.

An auction system can be used to operate the above transportation system. The auction system requires:
1. At least one of the sender and receiver placing an offer.
2. The proposing warehouse operators placing their bids.
3. The proposing vehicle drivers placing their bids.
4. Selecting the contributed warehouse from the proposed warehouses; and
5. Selecting the contributed vehicle from the proposed vehicles;
The contributed warehouse defines a stop along the route used to transport the parcel.

The transportation system can also include a payment mechanism for warehouse providers. For example, payments could be based on time and duration of warehousing, as well as weight and or volume of package, etc.

Crowdsourcing is defined as follow in Wikipedia: “Crowdsourcing represents the act of a company or institution taking a function once performed by employees and outsourcing it to an undefined (and generally large) network of people in the form of an open call. This can take the form of peer-production (when the job is performed collaboratively), but is also often undertaken by sole individuals. The crucial prerequisite is the use of the open call format and the large network of potential laborers. (Jeff Howe, Wikipedia article on crowdsourcing).” Even though crowdsourcing requires an “open call” as defined by Wikipedia, one still needs a filter to select the most appropriate service providers for a given job.

A difference between a conventionally operated transportation business and a crowdsourced transportation business as described in this invention is the level of integration of the services. The smallest possible services include the warehousing of a single parcel and the transportation of a single parcel between two warehouses. In this invention the transportation and warehousing services are broken down to their smallest possible elements (warehousing a single parcel, and transporting a single parcel along a single transportation leg) and assigned to the most appropriate crowdsourced service provider. The appropriateness of the provider is determined by a combination of things such as but not limited to, price, location, speed, storage availability and capability, transportation availability and capability, and parcel weight and size. From the crowdsourcing provider point of view, the transportation or warehousing service he provides can be worked into his daily routine and therefore presents little inconvenience. Of course, a given provider can warehouse or transport several parcels simultaneously but the level of task assignment is at the parcel level.

Another difference between a conventional and crowdsourcing operation is that conventionally the service provider is a single integrated business entity that interacts with customers and provides services (for example UPS or the US Postal Service, interacts with customers and owns or leases warehouses and/or transportation assets). In this crowdsourcing invention, there is no such integration. Senders, receivers, carriers and warehouse operators are independent business entities or individuals. Coordination of their operations is mediated through the crowdsourcing service provided by this invention. For example, when a package needs to be transported from a sender to a receiver and the transportation requires two legs with one stop in between, the stop location where the exchange takes place needs to have a warehouse for temporary storage of the package. (Of course there could be many stops and many warehouses). In crowdsourcing the carriers and warehouse operator do not have to be the same business entity, but their operation needs to be coordinated. The task of coordinating transportation and warehousing is performed by this invention.

This invention is a transportation system for transporting and warehousing parcels or other goods from a sender to a receiver, along a route comprising at least one stop at one warehouse. The transportation system uses crowdsourcing to generate warehousing facilities. This system comprises:
1. a network;
2. a remote server connected to the network and operated by a remote server operator;
3. a number of warehouses operated by crowdsourcing warehouse operators which are independent business entities. The warehouses are connected to the remote server by means of warehouse communication devices operating through the network.
4. The remote server coordinates the operation of the warehouses and selects which warehouses are used to temporarily store the parcel along the route.

Warehouse communication devices are used to send warehouse data such as availability to the remote server. This data is stored by the server, and used in selecting warehouses.

The transportation system also comprises a number of vehicles operated by crowdsourced drivers which are business entities independent of each other and of the remote server operator. The vehicles are connected to the remote server by means of a vehicle communication device. Information about the vehicles' position and availability is sent to the remote server. Using this information, the server selects which vehicles transport the parcel along the route between warehouses.

Senders access the remote server by means of communication devices. The senders specify parcel data, parcel identification code, a starting location, a terminating location, timing information such as desired speed of delivery, and the weight and size of the parcel.

The remote server comprises a web site configured to input the parcel data from the sender. The server also comprises a scheduler router module configured to utilize the parcel data, the warehouse data and the vehicle data to select a set of warehouses along a route and a set of vehicles to connect the selected warehouses.

The vehicles comprise a GPS system which generates GPS data. This data is transmitted to the server and used to track vehicles and to select appropriate vehicles to travel along route portions (i.e., legs) between warehouses.

Senders, receivers, warehouses and vehicles are assigned a custodian code. At the beginning of its journey, a parcel is given a parcel custody code initially assigned to be the code of the sender. As the parcel changes hands, the custody code changes accordingly until the parcel reaches the receiver.

Tracking of changes in custody is performed by initially generating a planned list of non-transitory successive custody for a given route. As the parcel is exchanged between drivers and warehouse operators, the changes in custody are verified against the planned list. If the change in custody is correct as planned, a non-transitory signal is issued, indicating that the parcel has changed custody. Otherwise a signal is issued indicating an incorrect potential change in custody.

Warehouse communication devices and vehicle communication devices are each assigned a communication device identification code. The communication devices are configured to communicate with each other and to mutually identify each other by their identification code. The mutual codes are used to verify the validity of the change in custody.

Parcels are tagged with a parcel identification code. The communication devices comprise a means of entry for the parcel identification code. This means of entry can be manual such as a keyboard or keypad, or in the form of a bar code, an RFID or the like. The parcel identification code is entered by the exchanging parties and used to verify that a change in custody is correct.

An impending exchange of a parcel is detected and signaled when two communication devices are in close proximity and their identification codes match entries in the planned list of successive custody.

A reputation record of each participating warehouse operator and vehicle driver is maintained and updated by senders or receivers.

The transportation system can also be operated as an auction. For example, the following process could be followed:
1. the sender and/or receiver making an offer;
2. warehouse operators placing their bids;
3. the winning warehouses being selected.

The auction could also include vehicle drivers:
1. The sender and/or receiver making their offers.
2. The warehouse operators placing their bids.
3. The vehicle drivers placing their bids;
4. Taking into account timing and routing constraints, warehouses and vehicles being selected.

### BRIEF DESCRIPTION OF THE DRAWINGS

FIG. 1 illustrates the transportation system comprised of crowdsourced warehouses and crowdsourced vehicles. Its operation is coordinated by a Cloud application.

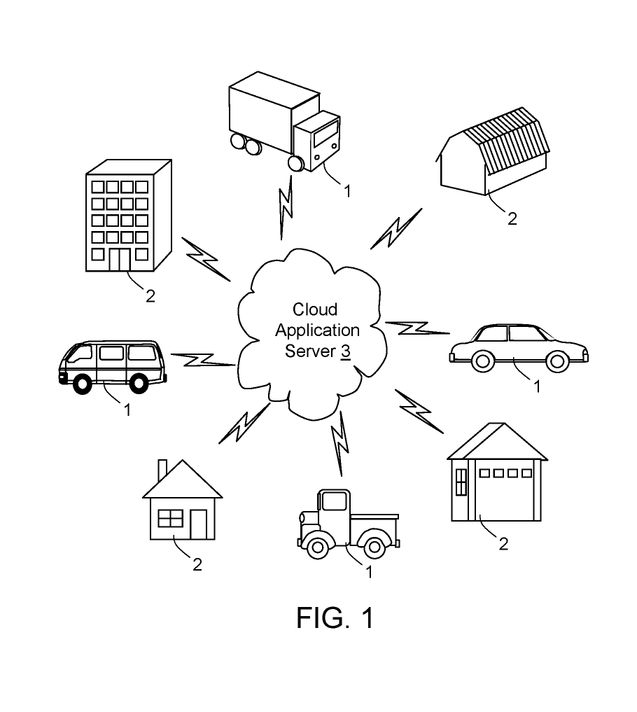

FIG. 2 shows block diagrams of the Cloud application and the communication devices.

FIG. 3 illustrates the nodal aspect of this transportation system.

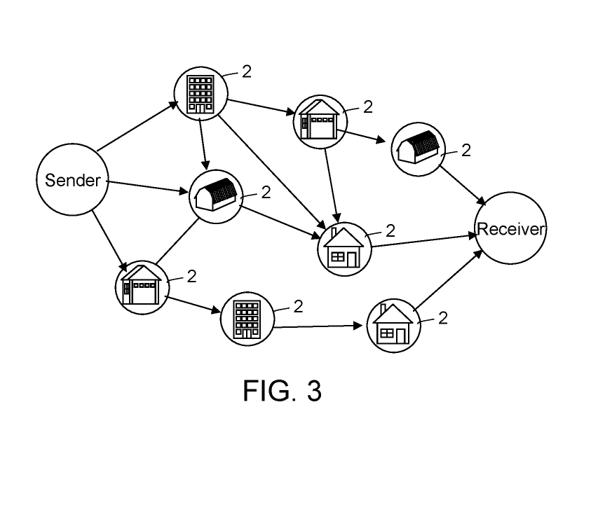

FIG. 4 shows a particular route assignment for a parcel to go from a sender to a receiver.

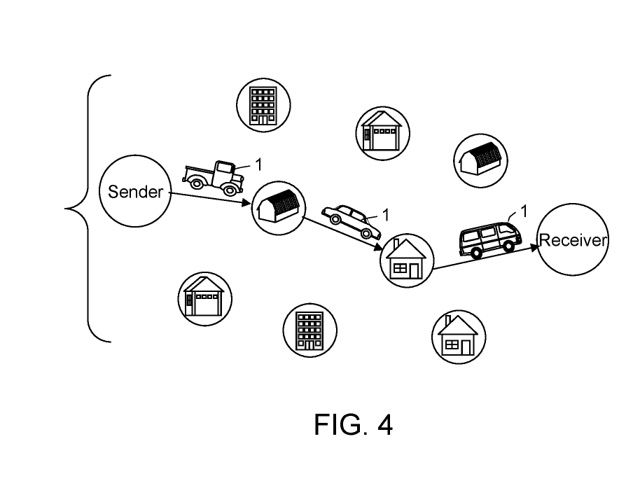

FIG. 5 provides a detailed breakdown showing the modules in the mobile communication device.

FIG. 6 illustrates the interaction between system modules during a scheduling operation.

FIG. 7 shows the interaction between different modules during a transaction or parcel exchange.

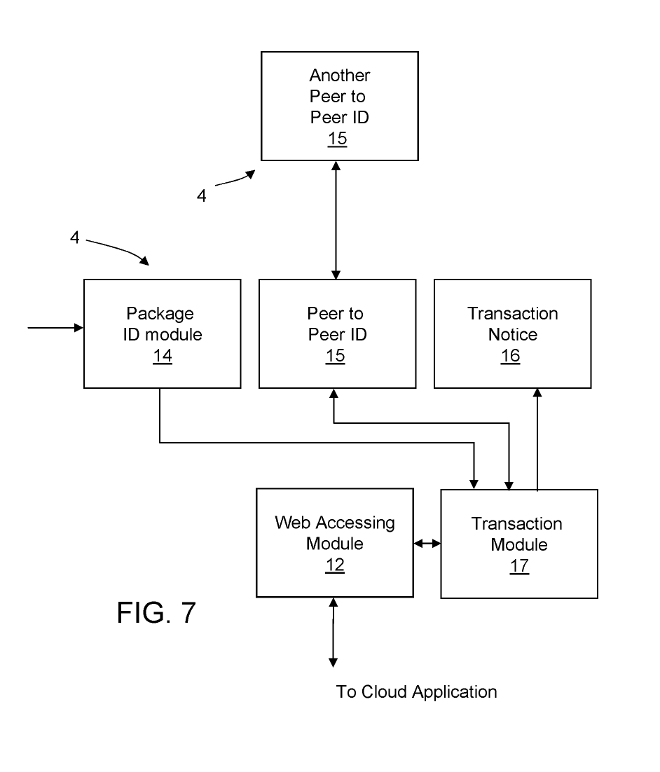

FIG. 8 provides a logical flow diagram of a transaction involving a change in the custody of a package.

FIG. 9 shows the operation of the router. It may include using auction data such as offers and bids, to compute a route.

### DETAILED DESCRIPTION

The invention is an internet marketplace that crowdsources residential, commercial or industrial facilities as well as transportation facilities, and coordinates their operations. The invention also coordinates these crowdsourced facilities with non-crowdsourced commercial warehouses and transportation vehicles. For the purpose of this application, crowdsourcing is defined as breaking up the task of transporting a parcel along a route from a sender to a receiver, into a number of legs and stops, and assigning the tasks of transporting the parcel along each leg to carriers, and of storing the parcel at each stop to warehouse operators, where at least one of the carriers or warehouse operators is selected from a networked community.

As shown in FIG.'s 1 and 2, the system comprises the following components:
1. Vehicles 1 capable of transporting packages, some of them provided by crowdsourcing participants called drivers.
2. Warehouses 2 located at different geographical sites, some of them provided by crowdsourcing participants called warehouse operators.
3. A Cloud application or remote application program 5 (possibly but not necessarily a Web site) residing at the server 3.
4. A Scheduler/Router Module 6 at the server 3.
5. A Vehicle Tracking Module 7 at the server 3.
6. A Mobile Communication App operating in the phones 4 of participants.
7. A Transaction Notice Module 8 at the server.
8. A Transaction Module 9 at the server.
9. A Reputation Module 10 at the server.

Vehicles 1 included in this transportation system could be conventional commercial transport vehicles or could be crowdsourced as in the Uber™ or Lyft™ transportation system.

Furthermore, warehouses 2 included in this transportation system could be conventional warehouses or could be crowdsourced such as garages in private residences, underutilized government buildings, or empty commercial rental offices.

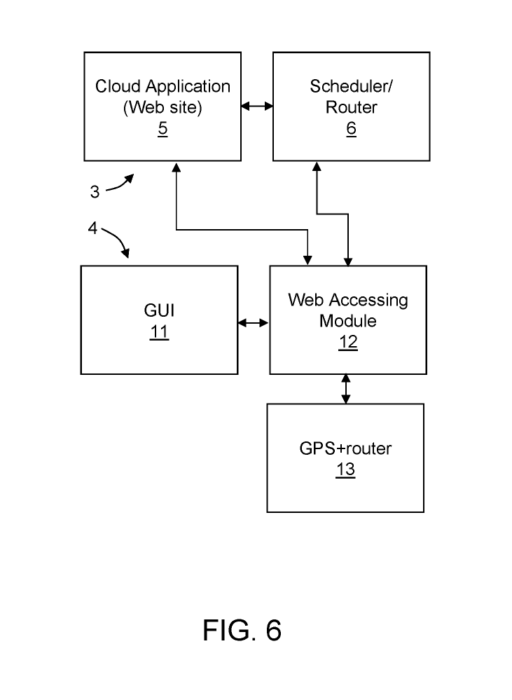

As shown in FIG. 6, the Cloud application program 5 allows participants to specify their contributions to the transportation system. This program can be but does not have to be a Web site. There are two kinds of participants: 1) drivers and 2) warehouse operators.
1. Drivers specify how they are willing to contribute. They enter information either using their browser at the web site, or by means of their phone app. They specify the kind of vehicles they drive, and the transportation capacity of the vehicle, and the range, areas or routes that they are willing to travel. They also provide calendaring and time availability. In addition their GPS location is generated in real time by the communication device app and transmitted to the server.
2. Warehouse operators specify the maximum area, security features and location of their storage facilities. The location of their warehouse may be entered manually into the mobile communication app or automatically generated by the GPS receiver in their mobile communication app. This location is transmitted to the server 3. Warehouse operators also specify their availability, for example, the days and times that they are available to receive or handling over packages.

The Scheduler/Router Module 6 utilizes the calendaring and time availability of the drivers and warehouse operators as well as the current locations of the drivers' vehicles 1 and the locations and the currently available storage areas of the warehouses 2 to calculate routes and schedule package exchange venues, (these routes and venues being non-transitory as they need to be stored for an extended period of time, for tracking and scheduling purposes and to be displayed). This process could make use of the Google routing system (or equivalent) available on the Web or on smart phones. The scheduling/routing algorithm could employ, for example, a dynamic programming approach to generate efficient and economical schedules and routes. FIG.'S 3 and 4 illustrates the dynamic and nodal aspects of this invention as it depends on the calendaring and availability of drivers and warehouse operators.

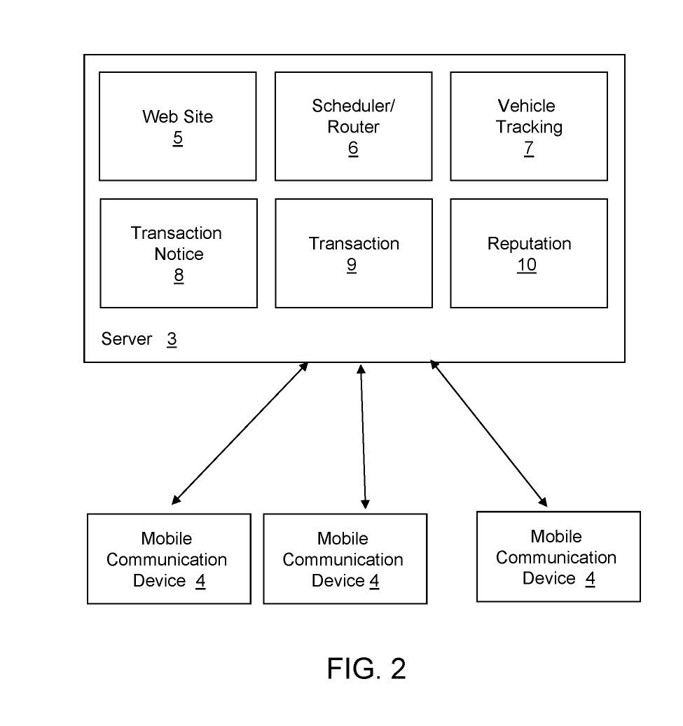

The Vehicle Tracking Module 7 shown in FIG. 2 relies on a GPS receiver typically available in smart phones. This module includes a vehicle tracking program at the server. The GPS output from the phone together with a driver identification code is transmitted to the server 3, thereby allowing the position of the vehicle 1 to be periodically updated at the server for schedule and tracking purposes.

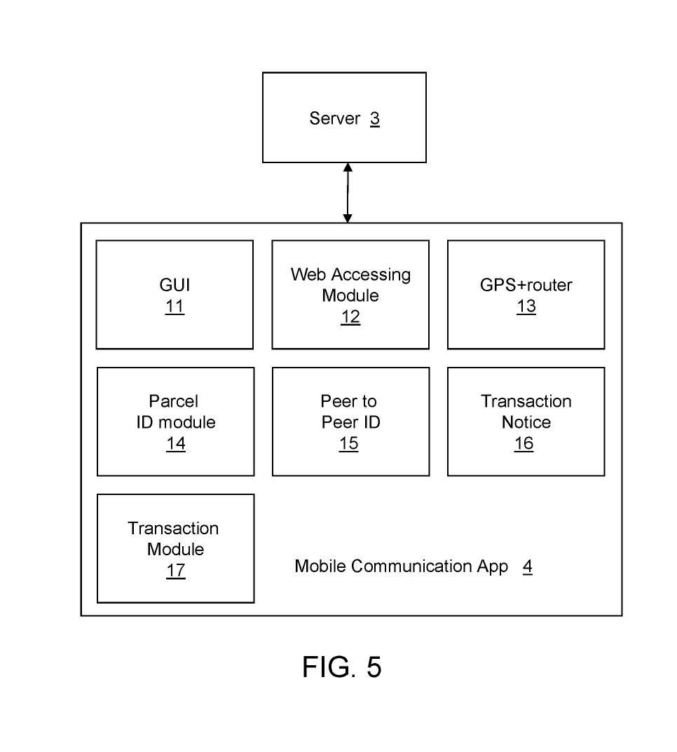

The Mobile Communication App shown in FIG. 5 resides in the phone 4 carried by the drivers or associated with the warehouse operators. It should be noted that the communication device operated by the warehouse operators obviously does not have to be “mobile.” For example, it could be a desktop computer. However, for the purpose of this discussion, we shall use the term “communication device” or “phone” even with regards the devices used by warehouse operators. This app includes the following components:
1. A Graphical User Interface 11 allowing the users as shown in FIG. 6, either the drivers or the warehouse operators, to enter relevant information required by the server, as specified above. For drivers, this includes the kind and capacity of their vehicles as well as their volunteered range, areas and routes. It also includes calendaring and time availability. For warehouse operators, this includes warehouse 2 location, area and security features. Warehouse operators also specify their calendaring and time availability. The graphical user interface also enables the participants to respond to non-transitory prompts generated by the server programs, in particular, the Scheduler/Router Module, the Vehicle Tracking Module, the Transaction Notice Module, and the Transaction Module. These prompts need to be stored for an extended period of time to be displayed and acknowledged.
2. Web accessing software 12 and hardware that allows the app to communicate with the server. This capability is available in smart phones. It could be in the form of a general purpose browser capable of accessing any web site or a special program dedicated to accessing the server 3.
3. A GPS receiver 13, as for example found in smart phones, that generates the location of the communication device. This location corresponds to a warehouse when the communication device is operated by a warehouse operator, and to a vehicle, when the communication device is operated by a driver. Routing software capable of generating routes, as is found in current smart phones, is also associated with this GPS module. This particular function supports drivers in finding the best routes.
4. A Package Identification Module 14 such as a bar code scanner using the phone's camera. There are many different kinds of bar codes, Q Codes, QR codes, image recognition devices etc . . . capable of identifying a package. Alternatively, the phone could be equipped with an RFID reader configured to read a corresponding RFID in the package.
5. A Short Range Phone to Phone Identification Module or Peer to Peer ID Module 15 that enables mutual identification of the participants in a package exchange. This module can utilize the short range communication system (e.g., BlueTooth™) available in smart phones. Essentially, the ID corresponding to each phone owner could be transmitted through the short communication link and mutually received by the other phone. Alternatively, a bar code could be displayed on each phone and mutually scanned by the phones' cameras and stored as non-transitory data. The purpose of this module is to produce non-transitory data for the purpose of verifying the validity and keeping a record of the transaction.

A Transaction Notice Module, with parts 8 and 16 respectively included in the server 3 and the communication device 4, notifies a driver and a warehouse operator that they are about to exchange a package. This transaction utilizes GPS information to determine that a driver's vehicle 1 is within a given range of, and approaching a warehouse 2, and that a package is about to be dropped off or picked up.

A Transaction Module also with parts 9 and 17 respectively included in the server 3 and in the communication device 4 is initiated by the participants involved in an exchange. Each participant in a transaction sends to this module the following:
1. A self identification code.
2. The identification code of the other participant involved in the transaction. This code can be generated by the Short Range Phone to Phone Identification Module. (Each participant in an exchange sends his own code and the code of the other participant).
3. An exchange code that identifies the type of exchange, for example, pick-up or drop-off. This code is entered by each participant in a transaction.
4. A code identifying the package being exchanged. This code can be generated by the Package Identification Module in the phone, for example by scanning the package or by means of an RFID tag.

Upon receiving the above information, the Transaction Module 9 at the server verifies that the transaction is performed according to plan. This module returns a transaction validation code to the transaction module 17 in the communication device 4 either confirming or denying the validity of the transaction. The participants complete the transaction by acknowledging that the transaction is completed. In addition, this module keeps track of the location of each package and updates the identity of the participant currently in possession of the package.

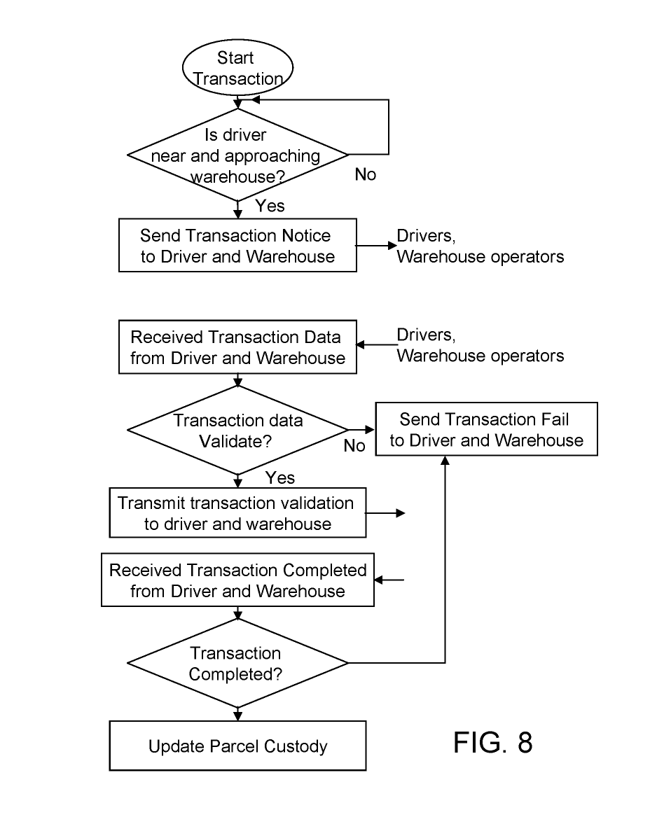

Steps used in the transaction are illustrated in the flow diagram shown in FIG. 8.

A Reputation Module 10 also located on the server, keeps track of the participants' performance. For example, a warehouse operator who is not available for an exchange in violation of his declared time commitment is penalized. Similarly, a driver carrying a package and committed to be within a particular GPS location or delivering a package within a pre-arranged time is also penalized. The output of the Reputation Module 10 can be used to select participants by the Scheduler/Router Module 6.

The task of the warehouse operator can be automatized by securing the warehouse facility with a smart lock or electronic lock connected to the Web. This smart lock can be remotely set up by the warehouse operator from anywhere using a PC or a smart phone. Set up with the proper code, the smart lock can be opened by drivers ready to make a pick-up or a drop-off and therefore, enables the warehouse operator to allow trusted drivers with a smart phone to access his warehouse. For example, a company, Lockitron, markets a device called “Bolt”, having some of these capabilities (Reference 1). According to the Lockitron web site: “Lockitron lets you instantly grant family, friends and guests access to your home or business from anywhere in the world using your internet enabled smart phone. It works with any smart phone and can detect the iPhone 4S or 5 on approach thanks to integrated Bluetooth Low Energy.”

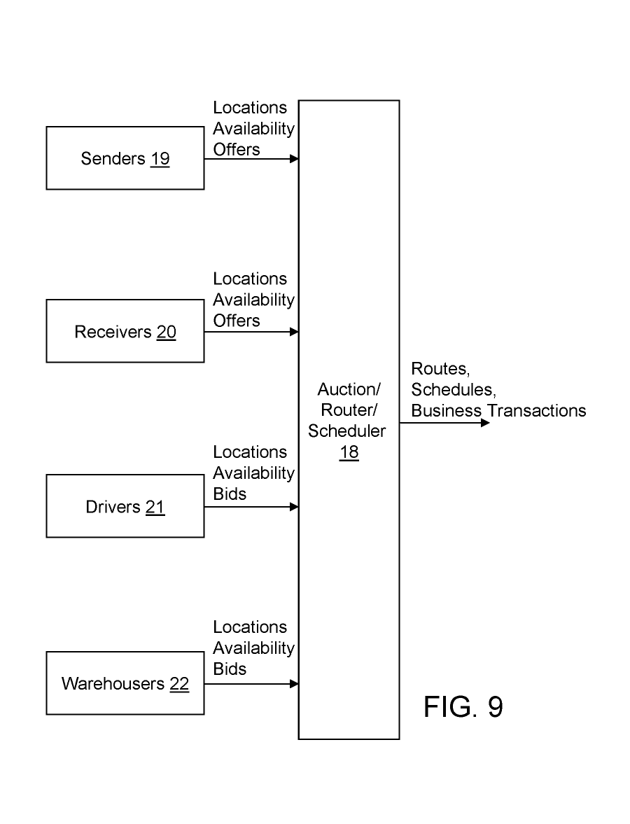

A variation of this invention shown in FIG. 9 includes an auction system in which senders 19 and receivers 20 state their offers and carriers 21 and warehouse operators 22 place their bids. A business transaction is agreed upon for transporting a parcel from a sender to a receiver when the cumulative offers by the sender and receiver of the parcel is equal to, or higher than, the cumulative bids by the carriers and warehouse operators along a route. A transaction cost can be included to monetize the operation of the auction system. The above auction is commonly called a Walrasian auction or Walrasian tâtonnement. One familiar with auctions will appreciate that many other types of auctions could be implemented such as the English, Dutch, sealed first-price or blind, Vickrey or sealed-bid second-price, multiunit, Japanese, no-reserve, reserve, reverse, silent, etc . . .

The routing task therefore involves finding a route that satisfies a business deal between senders, receivers, carriers, warehouse operators and auction operators. The router 18 can use an algorithm such as dynamic programming to solve such a routing problem. The terms of the auction (offers and bids) can include speed of delivery, and of course pick-up location (i.e., sender), drop-off location (i.e., receiver) and insurance of the parcel.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

### References

1. TechCrunch, “Lockitron Announces The $99 Bolt, A Deadbolt You Can Unlock With Your Phone” 2015/01/27.
2. Crowdsourcing article from Wikipedia, Dec. 18, 2006.
3. “Crowdsourcing Definition and More” Merriam-Webster.com. Aug. 31 2012. Retrieved 20171-2 Mar.

I claim:

1. A transportation system for transporting and warehousing at least one parcel from a sender to a receiver, along a route comprising at least one stop, said transportation system using crowdsourcing for warehousing said at least one parcel at said at least one stop, said transportation system comprising:
a. a network;
b. a remote server connected to said network and operated by a remote server operator;
c. a number of proposed warehouses operated by a number of proposing warehouse operators, at least two of said proposing warehouse operators being business entities independent of each other and of said remote server operator, said proposed warehouse being connected to said remote server through said network by means of a warehouse communication device;
d. at least one of said proposed warehouses being selected to perform said warehousing of said at least one parcel at said at least one stop, said selected proposed warehouses being called contributed warehouses, and said proposing warehouse operators of said contributed warehouses being called contributing warehouse operators; and
e. said contributed warehouse warehousing said at least one parcel.

2. The transportation system of claim 1 wherein said warehouse communication devices send non-transitory warehouse data to said remote server, said warehouse data being stored by said server, and used in performing selection of contributed warehouses.

3. The transportation system of claim 2 also comprising:
a. a number of proposed vehicles operated by a number of proposing vehicle drivers, at least two of said proposing vehicle drivers being business entities independent of each other and of said remote server operator, said proposed vehicles being connected to said remote server through said network by means of a vehicle communication device;
b. at least one of said proposed vehicles being selected to perform said transporting of said at least one parcel along said route, said selected proposed vehicles being called contributed vehicles and said proposing drivers of said contributed vehicles being called contributing drivers; and
c. said contributed vehicle transporting said at least one parcel.

4. The transportation system of claim 3 wherein vehicle communication devices send non-transitory vehicle data to said remote server, said vehicle data being stored by said server, and used in performing selection of contributed vehicles.

5. The transportation system of claim 4 also comprising sender communication devices operated by said senders and connected to said remote server through said network, said sender communication devices sending non-transitory parcel data to said remote server, said parcel data being stored by said server, and used to select said contributed vehicles and said contributed warehouses, said parcel data comprising a parcel identification code, a starting location of said route, a terminating location of said route, a timing information of said route, a weight of said at least one parcel, and a size of said at least one parcel.

6. The transportation system of claim 5 wherein said remote server comprises:
a. a web site module configured to input said parcel data from said sender;
b. a scheduler router module configured to utilize said parcel data, said proposed warehouse data, and said proposed vehicle data, to select contributed warehouses and contributed vehicles and furthermore, said scheduler router module configured to generate a non-transitory route comprising a number of legs connecting said starting location to said terminating location, through said contributed warehouses , and assigning each said leg to a said contributed vehicle, and furthermore, said route being assigned to said at least one parcel.

7. The transportation system of claim 6 wherein said contributing vehicles comprise a GPS system generating GPS data, said GPS data being transmitted to said remote server, said remote server comprising a vehicle tracking module that receives said GPS data, and wherein said scheduler router module utilizes said GPS data to select contributed warehouses and contributed vehicles and furthermore, generate said non-transitory route from said starting location to said terminating location, through said contributed warehouses.

8. The transportation system of claim 7 wherein
a. said contributing warehouse operators, said contributing drivers, said sender and said receiver are each assigned a non-transitory custodian code,
b. said parcel is assigned a non-transitory current custody code associated with a current custodian and being initialized to said sender,
c. said current custody code being updated from said current custodian to a next custodian every time a change in custody occurs as said parcel changes hands in succession along said route, starting from said sender, alternatively to said contributing warehouse operators and to said contributing drivers, and ending with said receiver.

9. The transportation system of claim 8 wherein a planned list of non-transitory successive custody codes is generated for said route.

10. The transportation system of claim 9 comprising a transaction module, said transaction module verifying that each said change in custody has a corresponding entry in said planned list of successive custody codes and upon a correct verification, sending out a non-transitory signal indicating a correct said change in custody, and updating current custody code, and furthermore upon incorrect verification sending out a signal indicating an incorrect said change in custody.

11. The transportation system of claim 10 wherein
a. each said warehouse communication device and said vehicle communication device is assigned a communication device identification code;
b. each said warehouse communication device and said vehicle communication device is configured to communicate with each other and mutually identify each other by their said communication device identification code; and
c. said mutual communication identification codes from said current custodian and said next custodian being sent to said transaction module and used to verify said change in custody.

12. The transportation system of claim 11 wherein
a. said parcel identification code is tagged on said parcel;
b. said warehouse communication devices and said vehicle communication devices also comprise a means of entry for said a parcel identification module;
c. said parcel identification code being read by said communication devices of said current custodian and by said communication devices of said next custodian and being sent to, and used by, said transaction module to verify said change in custody.

13. The transportation system of claim 12 wherein said means of entry include a machine readable tag on said parcel and wherein said warehouse communication devices and said vehicle communication devices are configured to non-transitorily read said machine readable tag.

14. The transportation system of claim 12 also comprising a transaction notice module, said transaction notice module utilizing said mutual communication identification codes and said planned list of successive custody codes to issue an impending transaction signal to be used by said current custodian and said next custodian to initiate a non-transitory change in custody.

15. The transportation system of claim 12 also comprising a non-transitory reputation record for each said proposing warehouse operator and each said proposing vehicle driver, said reputation record being updated by said senders or said receivers.

16. An auction system for operating said transportation system of claim 1, said auction system requiring:
a. at least one of said sender and said receiver placing their offers;
b. said proposing warehouse operators placing their bids; and
c. selecting said contributed warehouse from said proposed warehouses.

17. An auction system for operating said transportation system of claim 3, said auction system requiring:
a. at least one of said sender and said receiver placing their offers;
b. said proposing warehouse operators placing their bids;
c. said proposing vehicle drivers placing their bids;
d. selecting said contributed warehouse from said proposed warehouses; and
e. selecting said contributed vehicle from said proposed vehicles;
f. said contributed warehouse defining said stop.

18. The transportation system of claim 1 wherein said warehouse providers are paid a predetermined amount for warehousing said parcel.

19. The transportation system of claim 3 wherein said drivers are paid a predetermined amount for transporting said parcel.

20. The transportation system of claim 1 wherein said sender or receiver pays a predetermined amount for having said parcel transported along said route.
